(19) United States
(12) Patent Application Publication
(10) Pub. No.: US 2010/0305844 A1
(43) Pub. Date: Dec. 2, 2010

(54) MOBILE VEHICLE NAVIGATION METHOD AND APPARATUS THEREOF

(76) Inventors: Sung-Ha CHOI, Seoul (KR); Seung-Hoon Lee, Seongnam (KR)

Correspondence Address: BIRCH STEWART KOLASCH & BIRCH, PO BOX 747, FALLS CHURCH, VA, 22040-0747, US

(21) Appl. No.: 12/559,248

(22) Filed: Sep. 14, 2009

(30) Foreign Application Priority Data
Jun. 1, 2009 (KR) 10-2009-0048287

(51) Int. Cl. G01C 21/36

(52) U.S. Cl. 701/201

(57) ABSTRACT

A method and apparatus for receiving current location information; extracting photo images associated with areas selected by a user from map data, reading image capture location information from the extracted photo images, and calculating a route by way of the image captured locations of the extracted photo images based on the current location information and the read image capture location information; and outputting the route.

### CROSS REFERENCE TO RELATED APPLICATIONS

The present application is related to, and claims priority to, Korean patent application 10-2009-0048287, filed on Jun. 1, 2009, the entire contents of which is incorporated herein by reference.

### BACKGROUND OF THE INVENTION

1. Field of the Invention

The present invention relates to a mobile navigation device and method.

2. Description of the Related Art

In general, the related art navigation apparatus receives traffic information from a traffic information center and provides a route guidance service based on map data and current device location information. However, the related art has various operational and functional deficiencies that limited utility to a user.

### SUMMARY OF THE INVENTION

According to an aspect of the present invention, there is provided a navigation apparatus capable of being handheld or installed in a vehicle. The apparatus may include: a receiving unit configured to receive current location information; a controller configured to extract photo images associated with areas selected by a user from map data, read image capture location information from the extracted photo images, and calculate a route by way of the image captured locations of the extracted photo images based on the current location information and the read image capture location information; and an output unit configured to output the route.

According to another aspect of the present invention, there is provided a navigation method including: receiving current location information; extracting photo images associated with areas selected by a user from map data, reading image capture location information from the extracted photo images, and calculating a route by way of the image captured locations of the extracted photo images based on the current location information and the read image capture location information; and outputting the route.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram of a mobile communication terminal employing a navigation apparatus according to an exemplary embodiment of the present invention;

FIG. 2 illustrates a proximity touch for explaining a data display method according to an exemplary embodiment of the present invention;

FIG. 3 is a schematic block diagram of a navigation system for explaining a telematics terminal according to an exemplary embodiment of the present invention;

FIG. 4 is a schematic block diagram showing a telematics terminal employing the navigation apparatus according to the present invention;

FIG. 5 is a schematic block diagram of a navigation apparatus according to a first exemplary embodiment of the present invention;

FIG. 6 is a flow chart of a navigation method according to the first exemplary embodiment of the present invention;

FIG. 7 illustrates selecting an area from map data according to the first exemplary embodiment of the present invention;

FIG. 8 illustrates geo-tagged photo images associated with a selected area according to the first exemplary embodiment of the present invention;

FIG. 9 illustrates a route by way of image capture locations of the selected photo images according to the first exemplary embodiment of the present invention;

FIG. 10 is a flow chart of a navigation method according to a second exemplary embodiment of the present invention;

FIG. 11 illustrates a region in which a user can move on foot and a region in which the user can move by vehicle according to the second exemplary embodiment of the present invention;

FIG. 12 is a flow chart of a navigation method according to a third exemplary embodiment of the present invention;

FIG. 13 is a flow chart of a navigation method according to a fourth exemplary embodiment of the present invention; and

FIG. 14 is a flow chart of a navigation method according to a fifth exemplary embodiment of the present invention.

### DETAILED DESCRIPTION OF THE INVENTION

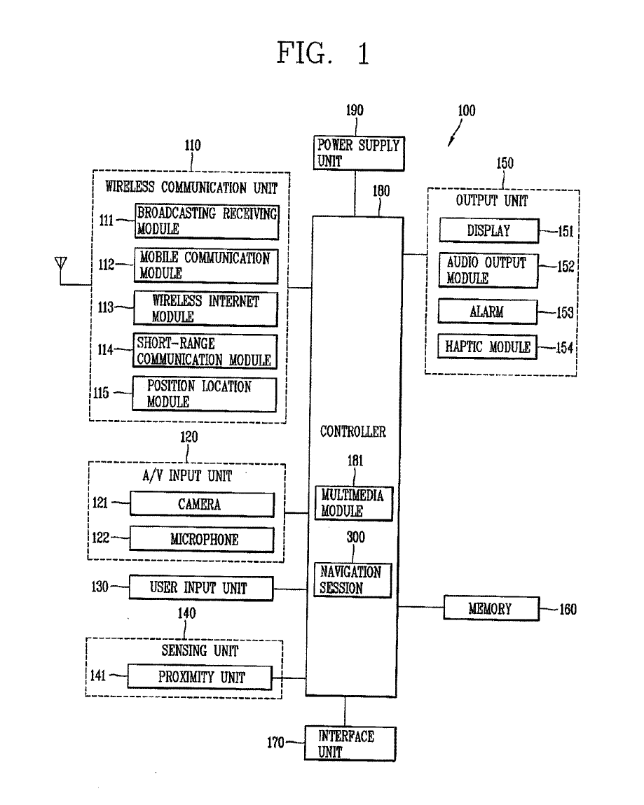

A navigation method and apparatus for receiving current location information, extracting photo images associated with areas selected by a user from map data, reading image capture location information from the extracted photo images, calculating a route by way of the image captured locations of the extracted photo images based on a current location and the read image capture location information, and outputting the route, thereby allowing a user to easily set a desired travel course and intuitively check the travel course (or a date course) according to exemplary embodiments of the present invention will now be described with reference to FIGS. 1 to 14.

FIG. 1 is a schematic block diagram showing the configuration of a mobile communication terminal employing an image display apparatus according to an exemplary embodiment of the present invention. The mobile communication terminal 100 may be implemented in various forms such as mobile phones, smart phones, notebook computers, digital broadcast terminals, PDAs (Personal Digital Assistants), PMPs (Portable Multimedia Player), etc.

As shown in FIG. 1, the mobile communication terminal 100 includes a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the mobile communication terminal 100 having various components, but it is understood that implementing all of the illustrated components is not a requirement. The mobile communication terminal 100 may be implemented by greater or fewer components.

The wireless communication unit 110 typically includes one or more components allowing radio communication between the mobile communication terminal 100 and a wireless communication system or a network in which the mobile communication terminal is located. For example, the wireless communication unit may include at least one of a broadcast receiving module 111, a mobile communication module 112, a wireless Internet module 113, a short-range communication module 114, and a position location module 115.

The broadcast receiving module 111 receives broadcast signals and/or broadcast associated information from an external broadcast management server (or other network entity) via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast associated information may refer to information associated with a broadcast channel, a broadcast program or a broadcast service provider. The broadcast signal may include a TV broadcast signal, a radio broadcast signal, a data broadcast signal, and the like. Also, the broadcast signal may further include a broadcast signal combined with a TV or radio broadcast signal.

The broadcast associated information may also be provided via a mobile communication network and, in this case, the broadcast associated information may be received by the mobile communication module 112. The broadcast signal may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems. Broadcast signals and/or broadcast-associated information received via the broadcast receiving module 111 may be stored in the memory 160 (or anther type of storage medium).

The mobile communication module 112 transmits and/or receives radio signals to and/or from at least one of a base station (e.g., access point, Node B, etc.), an external terminal (e.g., other user devices) and a server (or other network entities). Such radio signals may include a voice call signal, a video call signal or various types of data according to text and/or multimedia message transmission and/or reception.

The wireless Internet module 113 supports wireless Internet access for the mobile communication terminal. This module may be internally or externally coupled to the terminal. Here, as the wireless Internet technique, a wireless local area network (WLAN), Wi-Fi, wireless broadband (WiBro), world interoperability for microwave access (WiMAX), high speed downlink packet access (HSDPA), and the like, may be used.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The position location module 115 is a module for checking or acquiring a location (or position) of the mobile communication terminal (when the mobile communication terminal is located in a vehicle, the location of the vehicle can be checked). For example, the position location module 115 may be embodied by using a GPS (Global Positioning System) module that receives location information from a plurality of satellites. Here, the location information may include coordinate information represented by latitude and longitude values. For example, the GPS module may measure an accurate time and distance from three or more satellites, and accurately calculate a current location of the mobile communication terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites. As the position location module 115, a Wi-Fi position system and/or hybrid positioning system may be used.

The A/V input unit 120 is configured to receive an audio or video signal. The A/V input unit 120 may include a camera 121 (or other image capture device) and a microphone 122 (or other sound pick-up device). The camera 121 processes image data of still pictures or video obtained by an image capture device in a video capturing mode or an image capturing mode. The processed image frames may be displayed on a display unit 151 (or other visual output device).

The image frames processed by the camera 121 may be stored in the memory 160 (or other storage medium) or transmitted via the wireless communication unit 110. Two or more cameras 121 may be provided according to the configuration of the mobile communication terminal.

The microphone 122 may receive sounds (audible data) via a microphone (or the like) in a phone call mode, a recording mode, a voice recognition mode, and the like, and can process such sounds into audio data. The processed audio (voice) data may be converted for output into a format transmittable to a mobile communication base station (or other network entity) via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 (or other user input device) may generate key input data from commands entered by a user to control various operations of the mobile communication terminal. The user input unit 130 allows the user to enter various types of information, and may include a keypad, a dome switch, a touch pad (e.g., a touch sensitive member that detects changes in resistance, pressure, capacitance, etc. due to being contacted) a jog wheel, a jog switch, and the like. In particular, when the touch pad is overlaid on the display unit 151 in a layered manner, it may form a touch screen.

The sensing unit 140 (or other detection means) detects a current status (or state) of the mobile communication terminal 100 such as an opened or closed state of the mobile communication terminal 100, a location of the mobile communication terminal 100, the presence or absence of user contact with the mobile communication terminal 100 (i.e., touch inputs), the orientation of the mobile communication terminal 100, an acceleration or deceleration movement and direction of the mobile communication terminal 100, etc., and generates commands or signals for controlling the operation of the mobile communication terminal 100. For example, when the mobile communication terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device.

The interface unit 170 (or other connection means) serves as an interface by which at least one external device may be connected with the mobile communication terminal 100. For example, the external devices may include wired or wireless headset ports, an external power supply (or battery charger) ports, wired or wireless data ports, memory card ports, ports for connecting a device having an identification module, audio input/output (I/O) ports, video I/O ports, earphone ports, or the like. Here, the identification module may be a memory chip (or other element with memory or storage capabilities) that stores various information for authenticating user's authority for using the mobile communication terminal 100 and may include a user identity module (UIM), a subscriber identity module (SIM) a universal subscriber identity module (USIM), and the like.

In addition, the device having the identification module (referred to as the ‘identifying device’, hereinafter) may take the form of a smart card. Accordingly, the identifying device may be connected with the terminal 100 via a port or other connection means. The interface unit 170 may be used to receive inputs (e.g., data, information, power, etc.) from an external device and transfer the received inputs to one or more elements within the mobile communication terminal 100 or may be used to transfer data between the mobile communication terminal and an external device.

The output unit 150 is configured to provide outputs in a visual, audible, and/or tactile manner (e.g., audio signal, video signal, alarm signal, vibration signal, etc.). The output unit 150 may include the display unit 151, an audio output module 152, an alarm unit 153, and the like.

The display unit 151 may display information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, or the like. The mobile terminal 100 may include two or more display units (or other display means) according to its particular desired embodiment. For example, the mobile terminal may include both an external display unit (not shown) and an internal display unit (not shown).

Meanwhile, when the display unit 151 and the touch pad are overlaid in a layered manner to form a touch screen, the display unit 151 may function as both an input device and an output device. The touch sensor may have the form of, for example, a touch film, a touch sheet, a touch pad, and the like.

The touch sensor may be configured to convert the pressure applied to a particular portion of the display unit 151 or a change in capacitance generated at a particular portion of the display unit 151 into an electrical input signal. The touch sensor may be configured to detect a touch input pressure as well as a touch input position and a touch input area. When there is a touch input with respect to the touch sensor, the corresponding signal(s) are sent to a touch controller (not shown). The touch controller processes the signal(s) and transmits corresponding data to the controller 180. Accordingly, the controller 180 can recognize a touched region of the display unit 151.

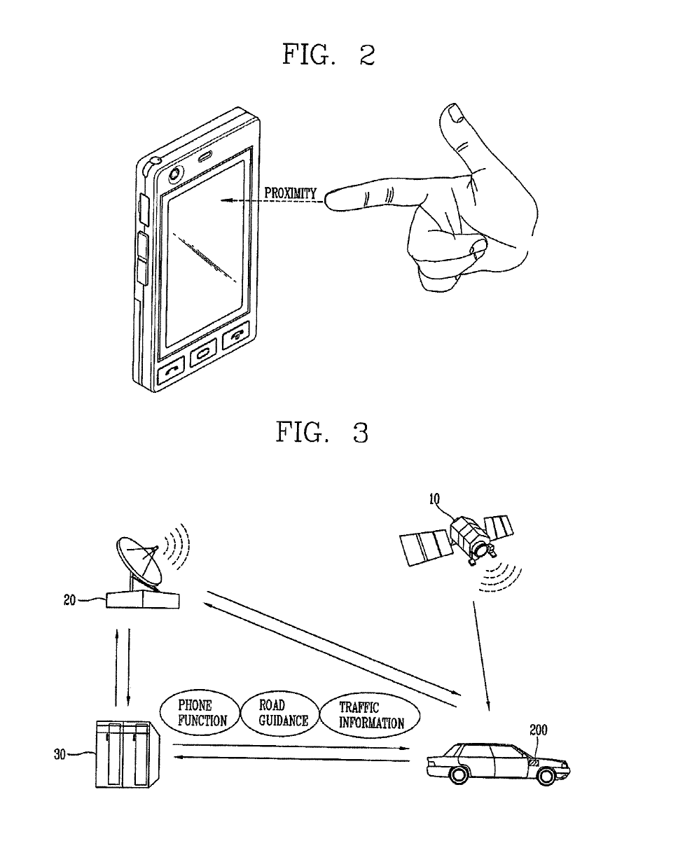

A proximity sensor 141 of the mobile communication terminal 100 will now be described with reference to FIG. 2.

FIG. 2 illustrates a proximity touch for explaining a data display method according to an exemplary embodiment of the present invention.

Proximity touch refers to recognition of the pointer positioned to be close to the touch screen without being in contact with the touch screen.

The proximity sensor 141 of FIG. 1 may be may be disposed within the mobile terminal 200 and may covered by the touch screen or may be near the touch screen. The proximity sensor 141 is a sensor for detecting the presence or absence of an object that accesses a specific detection surface of the mobile terminal or is a sensor for detecting the presence or absence of an object that exists nearby by using an electromagnetic force or infrared rays without a mechanical contact. Thus, the proximity sensor 141 has a longer life span compared with a contact type sensor, and it can be utilized for various purposes.

The proximity sensor 141 may be a transmission type photo sensor, a direct reflection type photo sensor, a mirror-reflection type photo sensor, an RF oscillation type proximity sensor, a capacitance type proximity sensor, a magnetic proximity sensor, an infrared proximity sensor. When the touch screen is an electrostatic type touch screen, an approach of the pointer is detected based on a change in an electric field according to the approach of the pointer. In this case, the touch screen (touch sensor) may be classified as a proximity sensor.

In the following description, for the sake of brevity, recognition of the pointer positioned to be close to the touch screen without being contacted will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

The proximity sensor 141 detects a proximity touch and a proximity touch pattern (e.g., a proximity touch distance, a proximity touch speed, a proximity touch time, a proximity touch position, a proximity touch movement state, or the like), and information corresponding to the detected proximity touch operation and the proximity touch pattern can be outputted to the touch screen.

The audio output module 152 may output audio data received from the wireless communication unit 110 or stored in the memory 160 in a call signal reception mode, a call mode, a record mode, a voice recognition mode, a broadcast reception mode, and the like. Also, the audio output module 152 may provide audible outputs related to a particular function (e.g., a call signal reception sound, a message reception sound, etc.) performed in the mobile terminal 100. The audio output module 152 may include a receiver, a speaker, a buzzer, etc.

The alarm unit 153 outputs a signal for informing about an occurrence of an event of the mobile terminal 100. Events generated in the mobile terminal may include call signal reception, message reception, key signal inputs, a touch input etc. In addition to video or audio signals, the alarm unit 153 may output signals in a different manner, for example, to inform about an occurrence of an event. The video or audio signals may be also outputted via the audio output module 152, so the display unit 151 and the audio output module 152 may be classified as parts of the alarm unit 153.

A haptic module 154 generates various tactile effects the user may feel. A typical example of the tactile effects generated by the haptic module 154 is vibration. The strength and pattern of the haptic module 154 can be controlled. For example, different vibrations may be outputted in unison or sequentially outputted.

Besides vibration, the haptic module 154 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 154 may be implemented to allow the user to feel a tactile effect through a muscle sensation such as fingers or arm of the user, as well as transferring the tactile effect through a direct contact. Two or more haptic modules 154 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with an external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores information for authenticating a user of the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via a port. The interface unit 170 may be used to receive inputs (e.g., data, information, power, etc.) from an external device and transfer the received inputs to one or more elements within the mobile terminal 100 or may be used to transfer data between the mobile terminal and an external device.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be separate from the controller 180.

The controller 180 may perform a pattern recognition processing to recognize a handwriting input or a picture drawing input performed on the touch screen as characters or images, respectively.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, procedures or functions described herein may be implemented by separate software modules. Each software module may perform one or more functions or operations described herein. Software codes can be implemented by a software application written in any suitable programming language. The software codes may be stored in the memory 160 and executed by the controller 180.

A navigation session 300 applied to the telematics terminal 200 generates road guidance information based on the map data and current location information of the vehicle and provides the road guidance information to a user.

The navigation apparatus applied to the mobile communication terminal 100 according to an exemplary embodiment of the present invention includes a position location module 115 for receiving current location information; the navigation session 300 (or a controller 180) for extracting geo-tagged photo images (or other geo-tagged images) associated with an area selected by a user from map data, extracting image capture location information from the extracted photo images, and calculating the shortest route by way of the image captured locations based on the current location information and the extracted image capture location information; and an output unit 150 (e.g., the display unit 151) for outputting the shortest route.

FIG. 3 is a schematic block diagram showing a vehicle navigation system for explaining a telematics terminal according to an exemplary embodiment of the present invention.

As shown in FIG. 3, a vehicle navigation system includes an information providing center 30 for providing traffic information and various data (e.g., programs, execution files, etc.); and a telematics terminal 200 that is mounted within a vehicle, receives traffic information via a remote wireless communication network 20 and/or short-range wireless communication network, and provides a road guidance service based on a GPS signal received via an artificial satellite 10 and the traffic information.

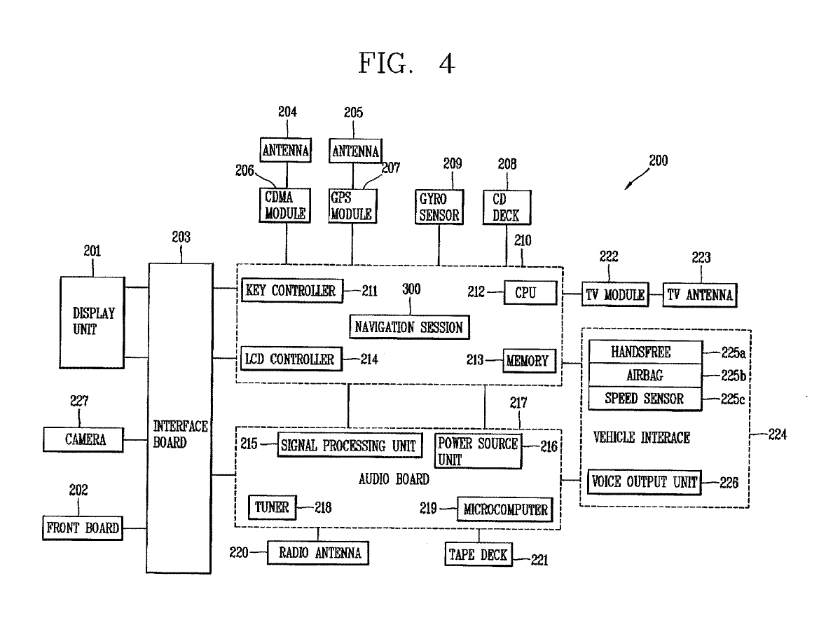

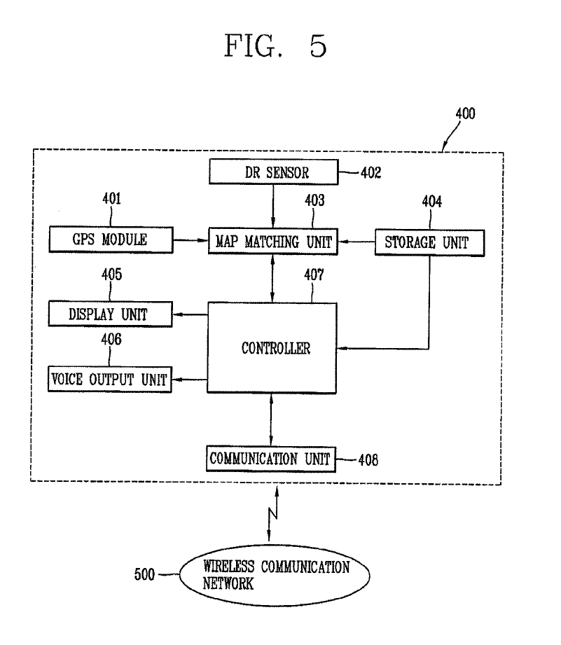

The configuration of the telematics terminal 200 employing a vehicle navigation apparatus according to an exemplary embodiment of the present invention will now be described with reference to FIG. 4.

FIG. 4 is a schematic block diagram showing a telematics terminal employing the vehicle navigation apparatus according to the present invention;

As shown in FIG. 4, the telematics terminal 200 includes a main board 210 including a CPU (Central Processing Unit) 212 for controlling the telematics terminal 200 overall, a memory 213 for storing various information, a key controller 211 for controlling various key signals, and an LCD controller 214 for controlling an LCD.

The memory 213 stores map information (map data) for displaying road guidance information on a digital map. Also, the memory 213 stores a traffic information collecting control algorithm for inputting traffic information according to the situation of a road along which the vehicle currently travels (runs), and information for controlling the algorithm.

The main board 210 includes a CDMA module 206, a mobile terminal having a unique device number as assigned and installed in the vehicle, a GPS module 207 for guiding a location of the vehicle, receiving a GPS signal for tracking a travel route from a start point to a destination, or transmitting traffic information collected by the user as a GPS signal, a CD deck 208 for reproducing a signal recorded in a CD (Compact Disk), a gyro sensor 209, or the like. The CDMA module 206 and the GPS module 207 receive signals via antennas 204 and 205.

A TV module 222 is connected with the main board 210 and receives a TV signal via a TV antenna 223. An LCD 201 under the control of the LCD controller 214, a front board 202 under the control of the key controller 211, and a camera 227 for capturing the interior and/or the exterior of a vehicle are connected to the main board 210 via an interface board 203. The LCD 201 displays various video signals and character signals, and the front board 202 includes buttons for various key signal inputs and provides a key signal corresponding to a button selected by the user to the main board 210. Also, the LCD 201 includes a proximity sensor and a touch sensor (touch screen).

The front board 202 includes a menu key for directly inputting traffic information. The menu key may be controlled by the key controller 211.

An audio board 217 is connected with the main board 210 and processes various audio signals. The audio board 217 includes a microcomputer 219 for controlling the audio board 217, a tuner 218 for receiving a radio signal, a power source unit 216 for supplying power to the microcomputer 219 and a signal processing unit 215 for processing various voice signals.

The audio board 217 also includes a radio antenna 220 for receiving a radio signal and a tape deck 221 for reproduce an audio tape. The audio board 217 may further include an amplifier 226 for outputting a voice signal processed by the audio board 217.

The amplifier 226 is connected to a vehicle interface 224. Namely, the audio board 217 and the main board 210 are connected to the vehicle interface 224. A handsfree module 225a for inputting a voice signal, an airbag 225b configured for the security of a passenger, a speed sensor 225c for detecting the speed of the vehicle, or the like, may be connected to the vehicle interface 224. The speed sensor 225c calculates a vehicle speed and provides the calculated vehicle speed information to the CPU 212.

The navigation session 300 applied to the telematics terminal 200 generates road guidance information based on the map data and current location information of the vehicle and provides the generated road guidance information to a user.

The display unit 201 detects a proximity touch within a display window via a proximity sensor.

For example, when a pointer (e.g., user's finger or stylus) closes to or touches the display unit 201, the display unit 201 recognizes a handwriting input (or handwriting data/handwriting message) according to the proximity touch or the contact touch and controls a menu (function) tagged to the recognized handwriting input. Here, the handwriting input is information inputted by the user, and various information such as English alphabets, Hangul, numbers, symbols, and the like, may be inputted.

Meanwhile, the vehicle navigation apparatus applied to the telematics terminal 200 according to an exemplary embodiment of the present invention includes: the GPS module 207 for receiving current location information of a vehicle; the navigation session 300 (or a controller 180) for extracting geo-tagged photo images associated with an area selected by a user from map data, extracting image capture location information from the extracted photo images, and calculating the shortest route by way of the image captured locations based on the current location information and the extracted image capture location information; and an output unit 150 (e.g., the display unit 151 or a voice output unit 226) for outputting the shortest route.

A navigation apparatus according to a first exemplary embodiment of the present invention will now be described with reference to FIG. 5. The navigation apparatus according to the first exemplary embodiment of the present invention may be applied to telematics terminal 200 and the mobile communication terminal 100, or may be independently configured. Also, the navigation apparatus according to exemplary embodiments of the present invention may be applicable to notebook computers, digital broadcasting terminals, personal digital assistants (PDAs), portable multimedia players (PMPs), or the like.

FIG. 5 is a schematic block diagram showing the configuration of the navigation apparatus 400 according to the first exemplary embodiment of the present invention.

As shown in FIG. 5, the navigation apparatus 400 according to the first exemplary embodiment of the present invention includes a GPS module 401 for receiving a GPS signal from a satellite and generating first vehicle location data of the navigation apparatus (regarded as the same location as the telematics terminal 200 or the mobile communication terminal 100) based on the received GPS signal; a DR (Dead-Reckoning) sensor 402 for generating second vehicle location data based on a travel direction and the speed of a vehicle; a storage unit (or a memory) 304 for storing map data and various information; a map matching unit 403 for generating an estimated vehicle location based on the first and second vehicle location data, matching the generated estimated vehicle location and a link (map matching link or a map matching road) in the map data stored in the storage unit 404, and outputting the matched map information (map matching results); a communication unit 408 for receiving real time traffic information from an information providing center via a wireless communication network 500 and performing call communication; a controller 407 for generating road guidance information based on the matched map information (map matching results); and a voice output unit 406 for outputting road guidance voice information (road guidance voice message) included in the road guidance information.

When a particular area on the map data is selected (dragged) by the user, the controller 407 reads photo images (i.e., geo-tagged photo images) associated with the selected area from the storage unit 404 or the information providing center (or a server) via the Internet, displays the read photo images, extracts image capture location information from the at least one or more photo images selected by the user, and calculates a route (e.g., the shortest route) by way of all of the captured locations based on the current location information and the extracted image capture location information. The display unit 405 displays the calculated route, and the voice output unit 406 outputs road guidance voice information corresponding to the route.

Here, the communication unit 408 may include a handsfree unit having a Bluetooth module.

The road guidance information may include information related to traveling such as route/lane information, travel (running) speed limit information, turn-by-turn information, traffic safety information, traffic guidance information, vehicle information, road search information, as well as the map data.

The signal received via the GPS module 401 may provide the location information of the terminal to the navigation apparatus 400 by using a wireless communication scheme such as 802.11, a standard of the wireless network for WLAN including wireless LAN, infrared communication, and the like, 802.15, a standard for a wireless personal area network (PAN) including Bluetooth™, UWB, ZigBee, and the like, 802.16, a standard for a wireless metropolitan area network (MAN) broadband wireless access (BWA) including a fixed wireless access (FWA), and the like, and 802.20, a standard for the mobile Internet with respect to a mobile broadband wireless access (MBWA) including WiBro, WiMAX, and the like, proposed by the IEEE (Institute of Electrical and Electronics Engineers).

The navigation apparatus 400 may further include an input unit. The input unit may select a user-desired function or receive information, and various devices such as a keypad, a touch screen, a jog shuttle, a microphone, and the like, may be used as the input unit.

The map matching unit 403 generates a vehicle estimated location based on the first and second vehicle location data, and reads map data corresponding to a travel route from the storage unit 404.

The map matching unit 403 matches the vehicle estimated location and a link (road) included in the map data, and outputs the matched map information (map matching results) to the controller 407. For example, the map matching unit 403 generates the vehicle estimated location based on the first and second location data, matches the generated vehicle estimated location and links in the map data stored in the storage unit 404 according to the link order, ad outputs the matched map information (map matching results) to the controller 407. The map matching unit 403 may output information regarding road attributes such as one-storied road, duplex-storied road, and the like, included in the matched map information (map matching results). The functions of the map matching unit 403 may be implemented in the controller 407.

The storage unit 404 stores map data. In this case, the stored map data includes geographic coordinates (or longitude/latitude coordinates) representing the latitude and longitude by DMS (Degree/Minute/Second) unit. Here, besides the geographic coordinates, universal transverse mercator (UTM) coordinates, universal polar system (UPS) coordinates, transverse mercator (TM) coordinates, and the like, may be also used as the stored map data.

The storage unit 404 stores information such as menu screen images, a point of interest (POI), function characteristics information according to a particular position of map data, and the like.

The storage unit 404 stores various user interfaces (UIs) and/or graphic UIs (GUIs).

The storage unit 404 stores data and programs required for operating the navigation apparatus 400.

The storage unit 404 stores destination information inputted from the user via the input unit. In this case, the destination information may be a destination or one of a destination and a start point.

The display unit 405 displays image information (or road guidance map) included in the road guidance information generated by the controller 407. Here, the display unit 405 includes a touch sensor (touch screen) and/or a proximity sensor. The road guidance information may include various information in relation to traveling (running, driving) such as lane information, running limit speed information, turn-by-turn information, traffic safety information, traffic guidance information, vehicle information, road search information, and the like, as well as the map data.

When displaying the image information, the display unit 405 may display various contents such as various menu screen images, road guidance information, and the like, by using a user interface and/or a graphic user interface included in the storage unit 404. Here, the contents displayed on the display unit 405 may include various text or image data (including map data or various information data), and a menu screen image including data such as icons, list menus, combo boxes, and the like.

The voice output unit 406 outputs voice information included in road guidance information (or a voice message with respect to the road guidance information) generated by the controller 407. Here, the voice output unit 406 may be an amplifier or a speaker.

The controller 407 generates the road guidance information based on the matched map information and outputs the generated road guidance information to the display unit 405 and/or the voice output unit 406. Then, the display unit 405 displays the road guidance information.

The controller 407 receives real time traffic information from the information providing center and generates road guidance information.

The controller 407 may be connected to a call center via the communication unit 408 to perform call communication, or transmit or receive information between the navigation apparatus 400 and the call center. Here, the communication unit 408 may include a handsfree module having a Bluetooth™ function using a short-range radio communication scheme.

The controller 407 detects a touch within a display window of the display unit 405 via a touch sensor or a proximity sensor. For example, when a point (e.g., the user's finger or stylus) is touched, the controller 407 selects a folder and/or file corresponding to the touch.

Meanwhile, when a particular area on the map data is selected (dragged) by the user, the controller 407 reads photo images associated with the selected area (i.e., geo-tagged photo images) from the storage unit or the information providing center (or server) via the Internet, and displays the read photo images on the display unit 405.

The controller 407 extracts image capture location information from one or more photo images selected by the user from the displayed photo images, and calculates a route (e.g., the shortest route) that goes through all the image captured locations based on the current location information and the extracted image capture location information. The display unit 405 displays the calculated route, and the voice output unit 406 outputs road guidance voice information corresponding to the route. Here, a method of adding image capture location information and time information to the photo images is disclosed in a U.S. Laid Open Publication No. 2007/0279438 (the entire contents of which are incorporated herein by reference), so its detailed description will be omitted.

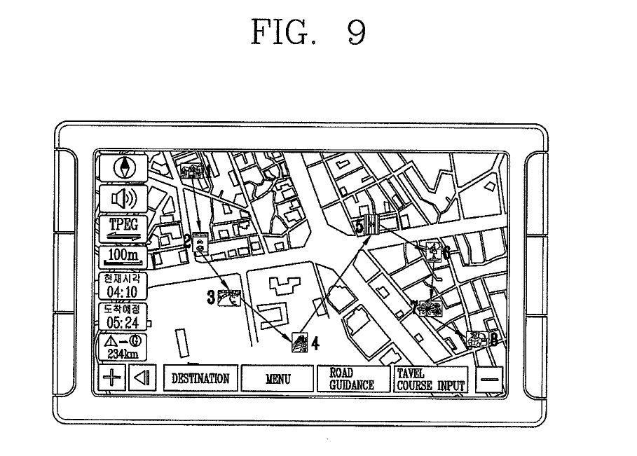

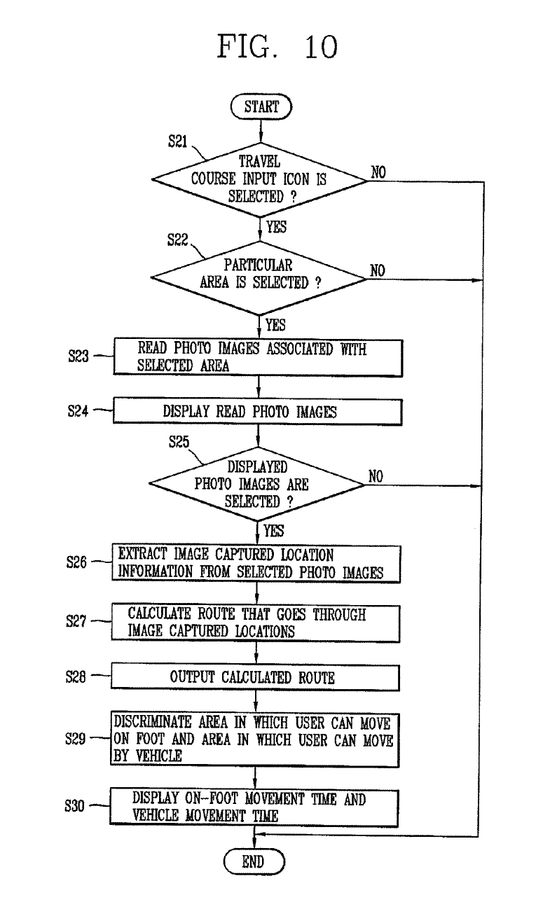

A navigation method according to a first exemplary embodiment of the present invention will now be described with reference to FIGS. 5 and 9.

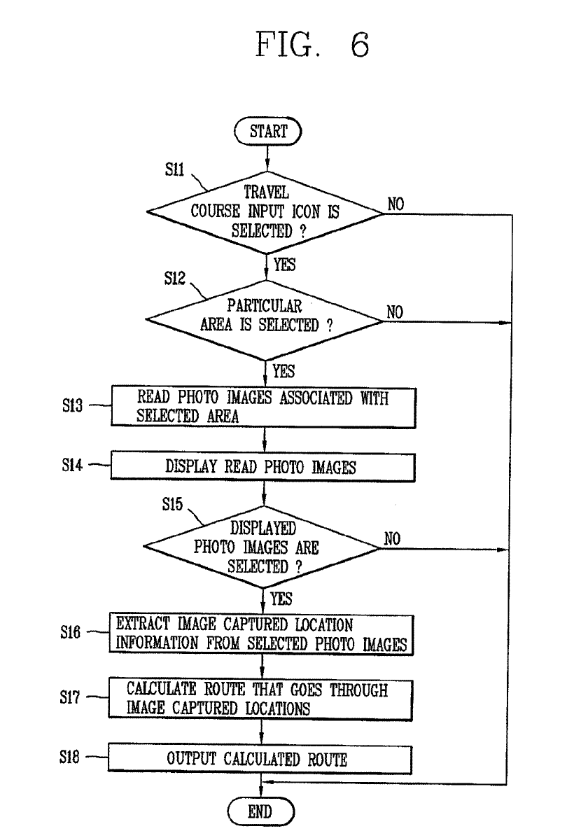

FIG. 6 illustrates a navigation method according to a first exemplary embodiment of the present invention.

First, the controller 407 determines whether or not a travel course input icon (or a photo image search icon for setting a route or a date course icon) is selected by the user (S11).

When the travel course input icon is selected by the user, the controller determines whether or not a particular area on the map data is selected (dragged) by the user (S12).

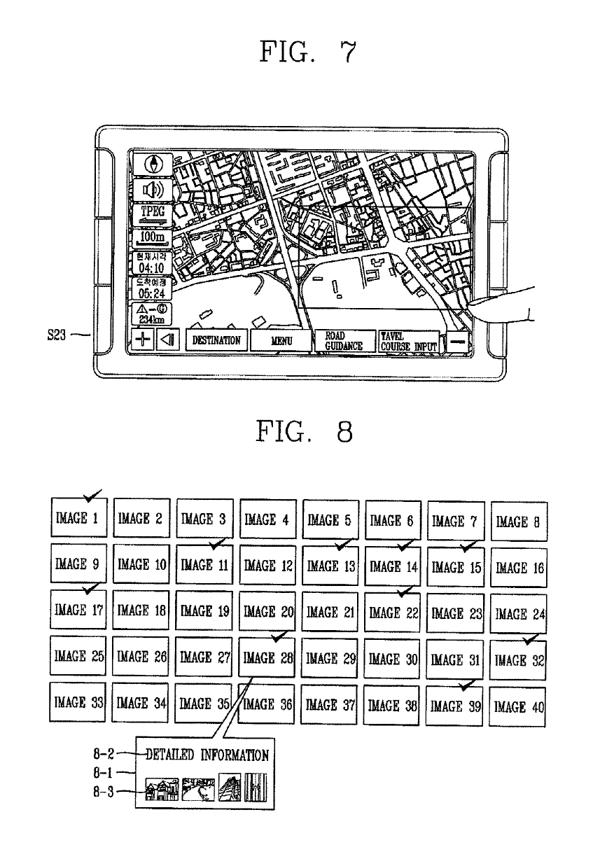

FIG. 7 illustrates selecting an area from map data according to the first exemplary embodiment of the present invention.

As shown in FIG. 7, when the travel course input icon is selected by the user, the controller 407 determines whether or not a particular area on the map data is selected (dragged) by the user. Here, when the user drags the particular area on the map data, the controller 407 may select the dragged area, or when the user inputs a character corresponding to an area (e.g., a city, a tourist area, etc.), the controller 407 may select the area corresponding to the inputted character.

When the particular area on the map data is selected by the user, the controller 407 reads photo images associated with the selected area (i.e., geo-tagged photo images) from the storage unit 404 or the information providing center (or server) via the Internet (S13) and displays the read photo images on the display unit 405 (S14).

The controller 407 checks whether or not some of the displayed photo images are selected by the user (S15), and if one or more photo images are selected by the user from among the displayed photo images, the controller 407 extracts (reads) image capture location information from the selected photo images (S16).

FIG. 8 illustrates geo-tagged photo images associated with the selected area according to the first exemplary embodiment of the present invention.

As shown in FIG. 8, when the particular area is selected by the user from the map data, the controller 407 reads photo images associated with the selected area (geotagged photo images) from the storage unit 404 or the information providing center (or server) via the Internet, and displays the read photo images on the display unit 405.

The controller 407 checks whether or not some of the displayed photo images are selected by the user, and if one or more photo images are selected by the user from among the displayed photo images, the controller may display one of a symbol, an icon, a pattern indicating that they have been selected, on the photo images. The photo images may be selected via a touch input, a voice command, or a button/rotary dial/other mechanical input. Also, if a particular photo image is selected one more times (e.g., double-clicked) by the user, the controller 407 may display detailed information (8-2) about the photo image in a pop-up window (8-1) and display additional photo images (i.e., photo images associated with a tourist area) associated with the selected photo image (e.g., a representative photo image of the tourist area).

The controller 407 calculates a route (e.g., the shortest route) that goes through all the image captured locations based on the current location information of the vehicle and the extracted image capture location information or other meta-data of the extracted image, and output the calculated information to the display unit 405 and/or the voice output unit 406 (S17).

The controller 407 may further display the distance from the current location to the image capture location on the selected photo image, the time required, transportation (going on foot, train, private car, bus, or the like) on the pop-up window. Here, if the selected photo image is related to a pleasure resort, the controller 407 may further display an admission fee on the pop-up window 8-1.

The controller 407 may further display weather information on the pop-up window 8-1. For example, the controller 407 may receive weather information of the image captured location of the selected photo image from the information providing center via a wireless communication network and display the received weather information on the pop-up window 8-1, so that the user may consider whether to visit the image captured location of the selected photo image upon checking the weather.

When the particular photo image is selected by the user, the controller 407 may display a three-dimensional photo image so that the 360-degree surrounding actual image based on the particular photo image.

FIG. 9 illustrates a route by way of image capture locations of the selected photo images according to the first exemplary embodiment of the present invention.

As shown in FIG. 9, the controller 407 may sort the location information read from the selected photo images according to the route order starting from image captured location closest to the current location information of the device/vehicle to calculate a route (e.g., the shortest route) that passes through all the image captured locations, and output the calculated information to the display unit 405 and/or the voice output unit 406. The controller 407 may give numbers to the location information read from the selected photo images according to the order starting from one closest to the current location information of the vehicle.

The controller 407 may display the selected photo images on the display unit 405 such that they are displayed each with a different brightness/color/shading/etc. according to an arrival expected time slot, so that the user can intuitively check whether one may expect to reach the corresponding location in the morning, in the afternoon, or at night. For example, if a time slot for the user to reach the image captured location of a photo ‘A’ comes in the morning based on the current location and current time, the controller 407 may display the photo ‘A’ brighter, and if a time slot for the user to reach an image captured location of the photo ‘B’ comes at night, the controller 407 may display the photo ‘B’ darker, so that the user can intuitively determine the time that the user is expected to reach the displayed image captured location.

Hereinafter, a navigation method according to a second exemplary embodiment of the present invention will now be described with reference to FIG. 5 and FIGS. 10 and 11.

FIG. 10 is a flow chart of a navigation method according to a second exemplary embodiment of the present invention.

First, the controller 407 checks whether or not the travel course input function or icon (or a photo image search function or icon for setting a route) is selected by the user (S21).

When the travel course input function or icon is selected by the user, the controller 407 checks whether or not a particular area on the map data is selected (dragged) by the user (S22).

When a particular area on the map data is selected by the user, the controller 407 a) reads photo images associated with the selected area (geo-tagged photo images) retrieved from the storage unit 404 or the information providing center (or server) via the Internet (S23) and b) displays the read photo images on the display unit 405 (S24).

The controller 407 checks whether or not some of the displayed photo images are selected by the user (S25), and if one or more photo images are selected by the user from among the displayed photo images, the controller may extracts (reads) the image capture location information from the selected photo images (S26).

The controller 407 checks whether or not some of the displayed photo images are selected by the user, and if one or more photo images are selected by the user from among the displayed photo images, the controller may display one of a symbol, an icon, a pattern indicating that they have been selected, on the photo images.

The controller 407 calculates a route (e.g., the shortest route) that goes through all the image captured locations (S27) based on the current location information of the vehicle and the extracted image capture location information, and outputs the calculated information to the display unit 405 and/or the voice output unit 406 (S28).

The controller 407 divides the calculated route into a region in which the user can move on foot and a region in which the user can move by vehicle (S29), and displays the time required for the user to move on foot and the time required for the user to move by vehicle on the display unit 405 (S30). Here, the time required for the user to move on foot and the time required for the user to move by vehicle may be previously calculated and stored in the storage unit 404.

When both the region in which the user can move on foot and the region in which the user can move by vehicle are included in the calculated route, the controller 407 may display a pop-up window (not shown) indicating the presence of regions in which the user can move on foot and by vehicle on the display unit 405. If an on-foot or vehicle icon (not shown) displayed on the pop-up window is selected by the user, the controller 407 indicates the route to a transportation node corresponding to the selected icon.

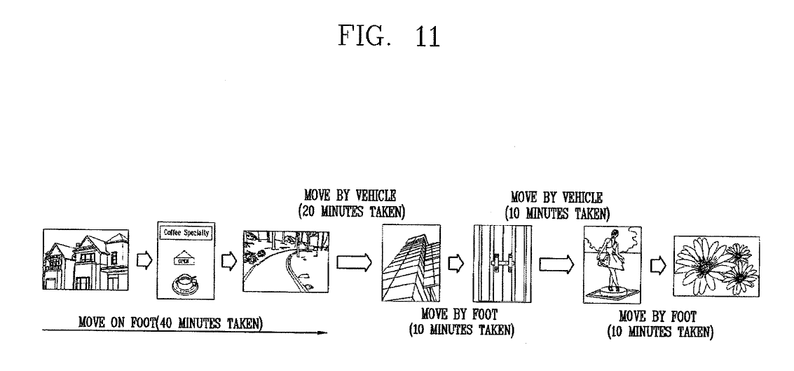

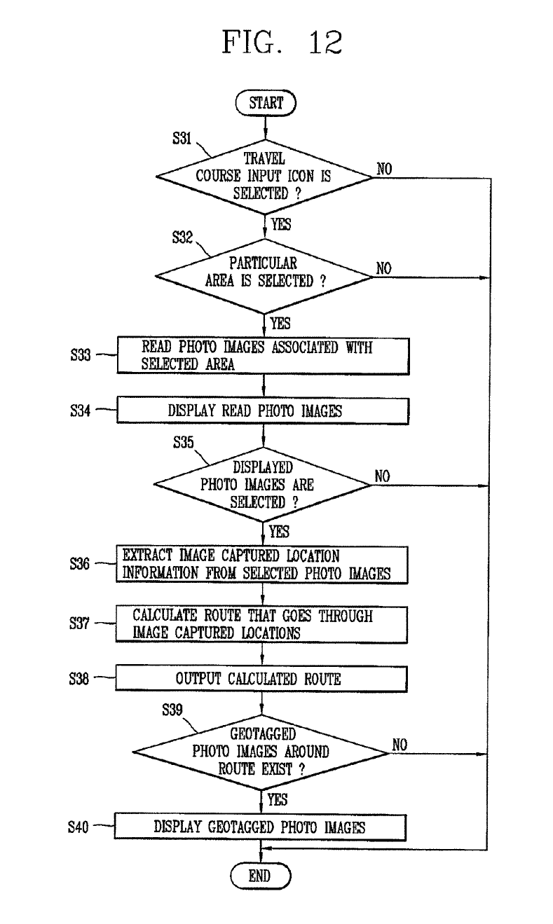

FIG. 11 illustrates a region in which the user can move on foot and a region in which the user can move by vehicle according to the second exemplary embodiment of the present invention.

As shown in FIG. 11, the controller 407 discriminates the region in which the user can move on foot and the region in which the user can move by vehicle, and displays the time/distance required for the user to move on foot and the time/distance required for the user to move by vehicle on the display unit 405. In addition, the controller 407 may also display the required time/distance for the entire route (i.e., from the current location to the location corresponding to the last photo image) on the display unit 405. Cost data (e.g., fuel costs, tolls, etc.) may also be displayed.

The controller 407 checks whether or not image captured locations of the photo images selected by the user from the calculated route are within a pre-set distance (e.g., 100 meters to 200 meters) of the route. If the image captured location of the selected photo images are within the pre-set distance, the controller 407 may group the photo images whose image captured locations are within the pre-set distance and guide the route corresponding to the grouped photo images, on foot, not by vehicle. Here, when the photo images whose image captured locations are within the pre-set distance are grouped, the controller 407 may search for parking lots present at or near the locations of the grouped photo images and guide the searched parking lots.

A navigation method according to a third exemplary embodiment of the present invention will now be described with reference to FIGS. 5 and 12.

FIG. 12 is a flow chart of a navigation method according to a third exemplary embodiment of the present invention.

First, the controller 407 checks whether or not the travel course input function/icon (or a photo search function/icon for setting a route) is selected by the user (S31).

When the travel course input function/icon is selected by the user, the controller 407 determines whether or not a particular area on the map data is selected (dragged) by the user (S32).

When a particular area on the map data is selected by the user, the controller 407 reads photo images associated with the selected area (geo-tagged photo images) from the storage unit 404 or the information providing center (or server) via the Internet (S33) and displays the read photo images on the display unit 405 (S34).

The controller 407 checks whether or not some of the displayed photo images are selected by the user (S35), and if one or more photo images are selected by the user from among the displayed photo images, the controller may extracts (reads) the image capture location information from the selected photo images (S36).

The controller 407 checks whether or not some of the displayed photo images are selected by the user, and if one or more photo images are selected by the user from among the displayed photo images, the controller may display one of a symbol, an icon, a pattern indicating that the photo images have been selected, on the photo images.

The controller 407 calculates a route (e.g., the shortest route) that goes through all the image captured locations based on the current location information of the device or vehicle and the extracted image capture location information (S37), and output the calculated information to the display unit 405 and the voice output unit 406 (S38).

While guiding the calculated route, the controller 407 checks whether or not geo-tagged photo images (e.g., geo-tagged photo images corresponding to travel destinations or tourist resort) corresponding to environs of the route exist (S39). For example, while guiding the calculated route, the controller 407 checks whether or not geo-tagged photo images corresponding to environs of the route (e.g., geo-tagged photo images corresponding to travel destinations or tourist locations) exist in the storage unit 404 or in the information providing center via the mobile communication network (e.g., based on the environs information such as information about environs of 1 km to 2 km from the current route).

If geo-tagged photo images (e.g., geo-tagged photo images corresponding to travel destinations or tourist resort) corresponding to environs of the route exist in the storage unit 404 or in the information providing center via the mobile communication network, the controller 407 reads the geo-tagged photo images and displays the read geo-tagged photo images on the display unit 405. Here, when the geo-tagged photo images (e.g., geo-tagged photo images corresponding to travel destinations or tourist resort) corresponding to environs of the route exist in the storage unit 404 or in the information providing center via the mobile communication network, the controller 407 may display the geo-tagged photo images according to popularity level (i.e., in the order starting from the photo image selected most frequently).

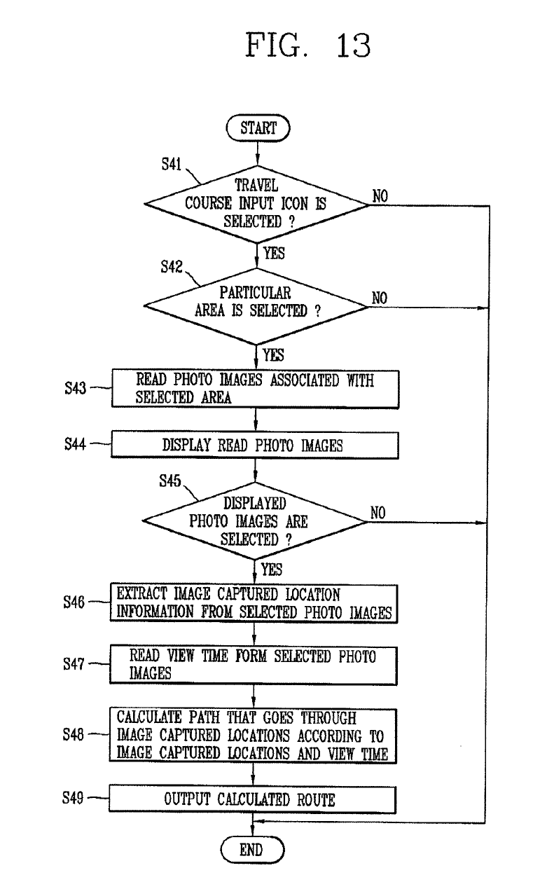

A navigation method according to a fourth exemplary embodiment will now be described with reference to FIGS. 5 and 13.

FIG. 13 is a flow chart of a navigation method according to a fourth exemplary embodiment of the present invention.

First, the controller 407 checks whether or not the travel course input icon (or a photo image search icon for setting a route) or function is selected by the user (S41).

When the travel course input function or icon is selected by the user, the controller 407 checks whether or not a particular area on the map data is selected (dragged) by the user (S42).

When a particular area on the map data is selected by the user, the controller 407 reads photo images associated with the selected area (geo-tagged photo images) from the storage unit 404 or the information providing center (or server) via the Internet (S43) and displays the read photo images on the display unit 405 (S44).

The controller 407 checks whether or not some of the displayed photo images are selected by the user (S45), and if one or more photo images are selected by the user from among the displayed photo images, the controller extracts (reads) the image capture location information from the selected photo images (S46).

When one or more photo images are selected by the user from among the displayed photo images, the controller 407 determines whether or not the selected photo images includes view time information (e.g., opening/closing times or a prearranged visit (sojourn) time duration), and if the selected photo images include view time information, the controller 407 reads the view time information from the selected photo images (S47). Time information is exemplary. Other information such as admission cost, etc. may be read.

In calculating a route by sorting the image captured locations in the order starting the one closest to the current location, the controller 407 preferentially calculates the route according to the image captured locations and the view time information (S48), and outputs the calculated route to the display unit 405 and the voice output unit 406 (S49). For example, if the view time of the selected photo images (e.g., the photo images of the travel destinations or tourist resort) comes in the morning, in the afternoon, or at night, the travel route order of the image captured locations corresponding to the selected photo images is changed such that the user can view (visit) the travel destinations (image captured locations) corresponding to the view time information at a time slot during which the user is available, rather than sorting the image captured locations in the order starting from the one closest to the current location. Accordingly, the user can view (visit) the travel destinations or tourist resort at a time slot during which he is available to see. In another embodiment, the locations can sorted by admission cost, so that less expensive locations are visited first so as to maximize a budget.

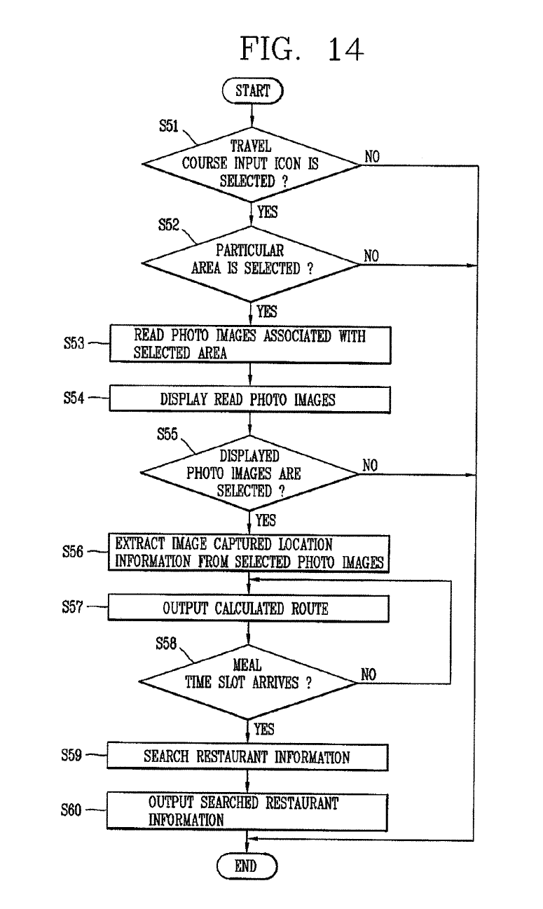

A navigation method according to a fifth exemplary embodiment of the present invention will now be described with reference to FIGS. 5 and 14.

FIG. 14 is a flow chart of a navigation method according to a fifth exemplary embodiment of the present invention.

First, the controller 407 determines whether or not the travel course input function or icon (or the photo image search function or icon for setting a route) is selected by the user (S51).

When the travel course input function or icon is selected by the user, the controller 407 determines whether or not a particular area on the map data is selected (dragged) by the user (S52).

When a particular area on the map data is selected by the user, the controller 407 reads photo images (geo-tagged photo images) associated with the selected area from the storage unit 404 (or an external detachable memory (not shown)) or from the information providing center (or server) via the Internet (S53) and displays the read photo images on the display unit 405 (S54).

The controller 407 determines whether or not some of the photo images are selected by the user (S55). If one or more photo images are selected by the user from among the displayed photo images, the controller 407 extracts (reads) image captured location information from the selected photo images (S56).

The controller 407 sorts the image captured locations in the order starting from the one closest to the current location to calculate a route, and outputs the calculated route to the display unit 405 and/or the voice output unit 406 (S57).

The controller 407 determines whether or not a meal time slot (e.g., noon (12 o'clock), 6:00 p.m., etc.) has arrived while the calculated route is being followed (S58). When the meal time slot has arrived, the controller 407 automatically searches restaurants (restaurant information) around the current route (S59). Alternatively, the controller 407 may estimate locations corresponding to a projected travel time. The controller 407 automatically searches and outputs information about restaurants near estimated route locations that correspond to pre-defined or user-defined meal times.

The controller 407 output the searched restaurant information to the display unit 405 and/or to the voice output unit 406 to provide the restaurant information to the user (S60). Also, in addition to or instead of restaurant time information, the controller 407 may output other time-related information and/or develop a route based on user-defined or predetermined time information (e.g., bridge opening/closing times, theater or park opening/closing times, etc.)

As so far described, the vehicle navigation method and apparatus according to the exemplary embodiments of the present invention have the following advantages.

That is, because photo images associated with an area selected by the user are extracted from map data, image captured location information is read from the extracted photo images, and a route that passes through the image captured locations is calculated based on the current location information and the read image captured location information and outputted, thereby easily setting a travel course desired by the user and allowing the user to intuitively check the travel course.

The previously described embodiments may be performed by a handheld device or a device installed in a vehicle. The vehicle may be an automobile, truck, bus, boat or other vehicle.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. A method of outputting navigation data from a navigation device, comprising:
within the navigation device, receiving or developing current location information;
selecting an area of interest based on a user area selection command;
extracting an image and associated image meta-data from stored or downloaded map data, the image associated with a location in the selected area;
calculating a route based on the current location information and the meta-data; and
outputting the route from the navigation device.

2. The method of claim 1, the step of outputting the route comprising:
outputting travel information for the location associated with the image, the travel information including one of a distance to the location from the current location or from the route, a time to travel to the location from the current location or from the route, and a mode of transportation to the location from the current location or from the route.

3. The method of claim 1, further comprising:
receiving and outputting weather information associated with one of the current location, the route and the location associated with the image.

4. The method of claim 1, the step of extracting an image and associated image meta-data comprises:
displaying a tag or icon representing the image; and
selecting the image based upon a user image selection input.

5. The method of claim 4, wherein the image is one of a plurality of extracted images, the method further comprising one of:
displaying the selected image with a brightness level or other visual characteristic different from a brightness level or other visual characteristic of a non-selected image; and
displaying the selected image with a brightness level or other visual characteristic different from a brightness level or other visual characteristic of another selected image according to a corresponding expected location arrival time.

6. The method of claim 1, the step of outputting the route comprising:
discriminating between pedestrian route segment and a vehicle route segment.

7. The method of claim 2, the step of outputting travel information comprising:
outputting directions to a parking lot at or near the location associated with the image.

8. The method of claim 1, wherein the image is one of a plurality of extracted images, the method further comprising:
displaying the plurality of extracted images according to a location popularity parameter.

9. The method of claim 1, wherein the meta-data includes time or schedule information for the location associated with the image.

10. The method of claim 9, wherein the time or schedule information includes meal time information, the method further comprising:
outputting travel information to or from a restaurant based on the meal time information.

11. A navigation device, comprising:
a display unit; and
a controller operatively connected to the display unit, the controller configured to
select an area of interest based on a user area selection command,
extract an image and associated image meta-data from stored or downloaded map data, the image associated with a location in the selected area,
calculate a route based on the current location information and the meta-data, and
output the route from the navigation device.

12. The navigation device of claim 11, wherein the controller is configured to output travel information for the location associated with the image, the travel information including one of a distance to the location from the current location or from the route, a time to travel to the location from the current location or from the route, and a mode of transportation to the location from the current location or from the route.

13. The navigation device of claim 11, wherein the controller is configured to receive and output weather information associated with one of the current location, the route and the location associated with the image.

14. The navigation device of claim 11, wherein the controller is configured to
display a tag or icon representing the image; and
select the image based upon a user image selection input.

15. The navigation device of claim 14,
wherein the image is one of a plurality of extracted images, and
wherein the controller is configured to
display the selected image with a brightness level or other visual characteristic different from a brightness level or other visual characteristic of a non-selected image, and
display the selected image with a brightness level or other visual characteristic different from a brightness level or other visual characteristic of another selected image according to a corresponding expected location arrival time.

16. The navigation device of claim 11, wherein the controller is configured to discriminate between pedestrian route segment and a vehicle route segment.

17. The navigation device of claim 12, wherein the controller is configured to output directions to a parking lot at or near the location associated with the image.

18. The navigation device of claim 11,
wherein the image is one of a plurality of extracted images, and
wherein the controller is configured to display the plurality of extracted images according to a location popularity parameter.

19. The navigation device of claim 11, wherein the meta-data includes time or schedule information for the location associated with the image.

20. The navigation device of claim 19,
wherein the time or schedule information includes meal time information, and
wherein the controller is configured to output travel information to or from a restaurant based on the meal time information.

21. A motor vehicle, comprising:
a navigation device including a display unit and a controller operatively connected to the display unit, the controller configured to
select an area of interest based on a user area selection command,
extract an image and associated image meta-data from stored or downloaded map data, the image associated with a location in the selected area,
calculate a route based on the current location information and the meta-data, and
output the route from the navigation device.
